(19) United States
(12) Patent Application Publication
(10) Pub. No.: US 2010/0001985 A1
(43) Pub. Date: Jan. 7, 2010

(54) DOT-MATRIX DISPLAY CHARGING CONTROL METHOD AND SYSTEM

(76) Inventors: Chun-Hsi Chen, Taipei (TW); Jean-Fu Kiang, Taipei (TW)

Correspondence Address: SCHMEISER, OLSEN & WATTS, 22 CENTURY HILL DRIVE, SUITE 302, LATHAM, NY, 12110, US

(21) Appl. No.: 12/167,379

(22) Filed: Jul. 3, 2008

(51) Int. Cl. G09G 5/00; G09G 3/36

(52) U.S. Cl. 345/214; 345/92

(57) ABSTRACT

A dot-matrix display charging control method and system is proposed, which is designed for integration to a dot-matrix display device, such as a TFT-LCD (Thin Film Transistor Liquid Crystal Display), for controlling a data-refresh process on the dot-matrix display device. The proposed method and system is characterized by the capability of concurrently selecting a number of consecutive pixel rows in the dot-matrix panel for charging all of the pixel rows with the same set of data voltages from a master data row that is intended to be applied to one of the selected pixel rows, and then fine-tuning every other pixel row with a set of differential voltages based on the value differences between the master data row and a slave data row that is intended to be applied to the other pixel row. This feature allows the operation of a dot-matrix display device to use a long charging time for data refresh under a fast scan speed.

### BACKGROUND OF THE INVENTION

1. Field of the Invention

This invention relates to dot-matrix display technology, and more particularly, to a dot-matrix display charging control method and system which is designed for integration to a dot-matrix display device, such as TFT-LCD (Thin Film Transistor Liquid Crystal Display), for controlling a data-refresh process on the dot-matrix display device.

2. Description of Related Art

TFT-LCD (Thin Film Transistor Liquid Crystal Display) is a widely used dot-matrix display technology on electronic devices with a screen display such as notebook computers and intelligent mobile phones. In practice, a TFT-LCD device is equipped with an N×M dot-matrix panel which is an array of N rows and M columns of pixels, wherein each pixel is capable of displaying a particular color value in response to the charging of a particular level of data voltage thereto.

With technological advance, dot-matrix display devices have evolved from the early 640×480 resolution to modern high-definition resolutions such as 1920×1080 or higher. However, due to the increase in the amount of pixels, one important issue in the design of high-definition dot-matrix display devices is that the data-refresh process should be faster in order to maintain a fast scan speed for real-time display of video data. In other words, the charging of data voltage on each pixel should be completed in a shorter time period. However, a reduced shorter time period for data voltage charging would undesirably cause insufficient charging and thus incorrect color values displayed on the pixels.

In view of the foregoing issues in the design of dot-matrix display devices, there exists therefore a need in the electronic and computer industry for a new and improved dot-matrix display technology that allows a longer charging time during data-refresh process but nevertheless allows the use of a fast scan speed.

### SUMMARY OF THE INVENTION

It is therefore an objective of this invention to provide a dot-matrix display charging control control method and system that allows the operation of a dot-matrix display device to use a longer charging time for data refresh under a fast scan speed.

Conceptually, the invention is defined as a method comprising: (M1) periodically generating a predetermined number of scan signals including a master scan signal and at least one slave scan signal during a predefined scan period; wherein each scan period is divided into a master charging stage and at least one succeeding fine-tuning stage; (M2) during the master charging stage of each scan period, setting the scan signals to concurrently switch a corresponding number of pixel rows in the dot-matrix display device to charging-enabled state, and then charging a set of data voltages associated with the pixel row activated by the master scan signal to all the pixel rows selected by the scan signals; and (M3) during each fine-tuning stage of the scan period, setting the master scan signal to switch the corresponding pixel row to charging-inhibited state and meanwhile setting each slave scan signal to sequentially activate the corresponding pixel row to charging-enabled state, and then charging a set of fine-tuning voltages which are based on the differences between a master data row and a slave data row that are to be refreshed to the pixel rows selected by the master scan signal and each slave scan signal.

In architecture, the invention is defined as a system comprising: two separate units: (A) a scan circuit; and (B) a data drive circuit; wherein the scan circuit includes: (A1) a scan-signal generating module; and (A2) a sequential-output control module 120; and wherein the data drive circuit includes: (B1) a data-latching module; (B2) a DAC array module; (B3) a fine-tuning voltage generating module; and (B4) a sequential voltage output control module.

The dot-matrix display charging control method and system according to the invention is characterized by the capability of concurrently selecting a number of consecutive pixel rows in the dot-matrix panel for charging all of the pixel rows with the same set of data voltages from a master data row that is intended to be applied to one of the selected pixel rows, and then fine-tuning every other pixel row with a set of differential voltages based on the value differences between the master data row and a slave data row that is intended to be applied to the other pixel row. This feature allows the operation of a dot-matrix display device to use a long charging time for data refresh under a fast scan speed.

### BRIEF DESCRIPTION OF DRAWINGS

The invention can be more fully understood by reading the following detailed description of the preferred embodiments, with reference made to the accompanying drawings, wherein:

FIGS. 1A-1B are schematic diagrams showing the application of the dot-matrix display charging control system of the invention with a dot-matrix display device;

FIG. 2 is a schematic diagram used to depict the writing of a full video frame into a dot-matrix panel;

FIG. 3 is a schematic diagram showing the architecture of the dot-matrix display charging control system of the invention;

FIGS. 4A-4C are schematic diagrams showing the internal circuit architecture of three scan-signal generators that constitute the scan-signal generating module utilized by the invention;

FIG. 5 is a schematic diagram showing the internal architecture of the data drive circuit utilized by the invention;

FIGS. 6A-6C are schematic diagrams showing the internal circuit architecture of the fine-tuning voltage generating module utilized by the invention and the internal architecture of each individual fine-tuning voltage generator utilized by the fine-tuning voltage generating module;

FIG. 7 is a schematic diagram showing an example of a practical realization of the data drive circuit utilized by the invention;

FIG. 8 is a waveform diagram showing the waveforms and sequencing of a set of scan signals utilized by the invention.

### DETAILED DESCRIPTION OF PREFERRED EMBODIMENTS

The dot-matrix display charging control method and system according to the invention is disclosed in full details by way of preferred embodiments in the following with reference to the accompanying drawings.

### Function and Application of the Invention

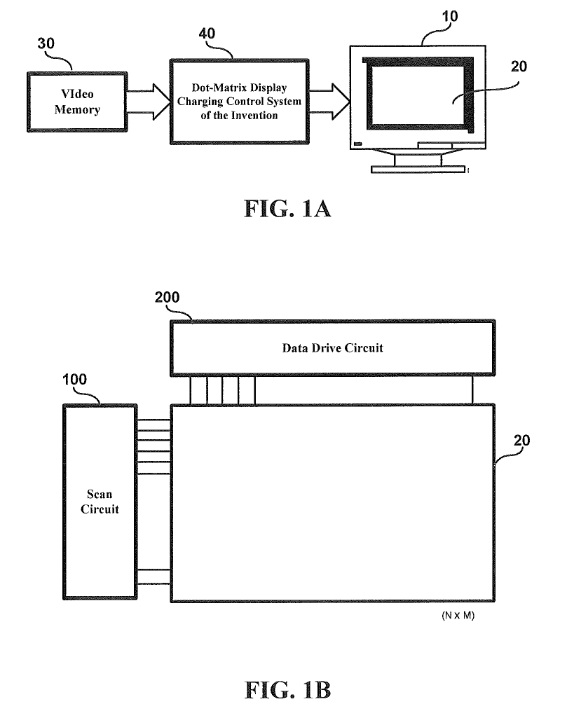

FIGS. 1A-1B are schematic diagrams showing the application of the dot-matrix display charging control system of the invention (which is here encapsulated in a box indicated by the reference numeral 40). As shown, the dot-matrix display charging control system of the invention 40 is designed for integration to a dot-matrix display device 10, such as a TFT-LCD (Thin Film Transistor Liquid Crystal Display) device, that is equipped with an N×M dot-matrix panel 20 which is an array of N rows and M columns of pixels, and is further coupled to a video memory 30. In operation, the dot-matrix display charging control system of the invention 40 is capable of controlling a data-refresh process on the dot-matrix display device 10 for the purpose of displaying a sequence of video frame data cached in the video memory 30 on the dot-matrix panel 20.

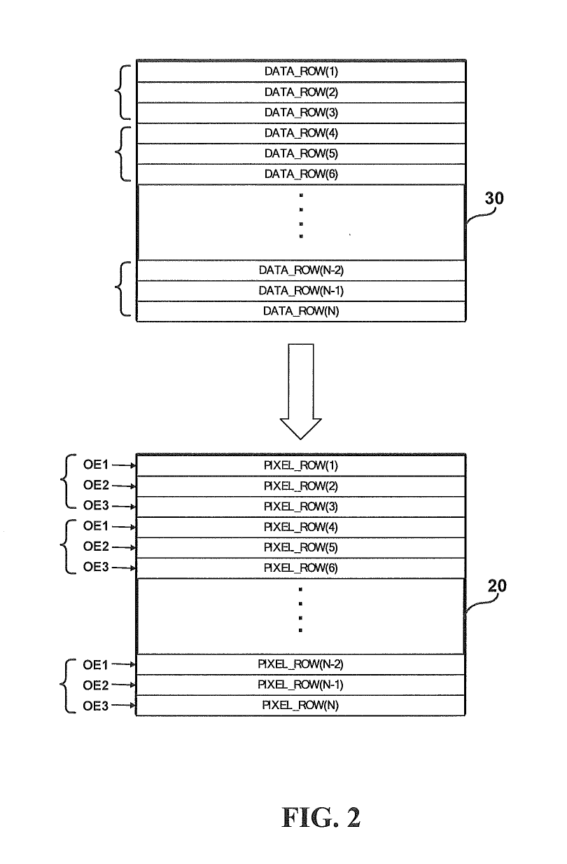

As shown in FIG. 2, the N×M dot-matrix panel 20 is composed of N pixel rows, which are respectively expressed as PIXEL_ROW(1), PIXEL_ROW(2) . . . , and PIXEL_ROW(N), wherein each pixel row contains M pixels. On the other hand, the video memory 30 is used to cache the digitized data of a sequence of video frames that are to be displayed on the dot-matrix panel 20, wherein each video frame is composed of N rows of pixel data, which are respectively expressed as DATA_ROW(1), DATA_ROW(2) . . . , and DATA_ROW(N), and wherein each data row contains M pixels of data, and each pixel of data represents a color value that is to be displayed on the corresponding pixel on the dot-matrix panel 20.

In operation, the dot-matrix display charging control system of the invention 40 is used to write the data rows in the video memory 30 in the form of analog data voltages to corresponding pixel rows in the dot-matrix display device 10; i.e., the first data row DATA_ROW(1) is written to the first pixel row PIXEL_ROW(1), the second data row DATA_ROW(2) is written to the second pixel row PIXEL_ROW(2), the third data row DATA_ROW(3) is written to the third pixel row PIXEL_ROW(3), and so forth.

### Architecture of the Invention

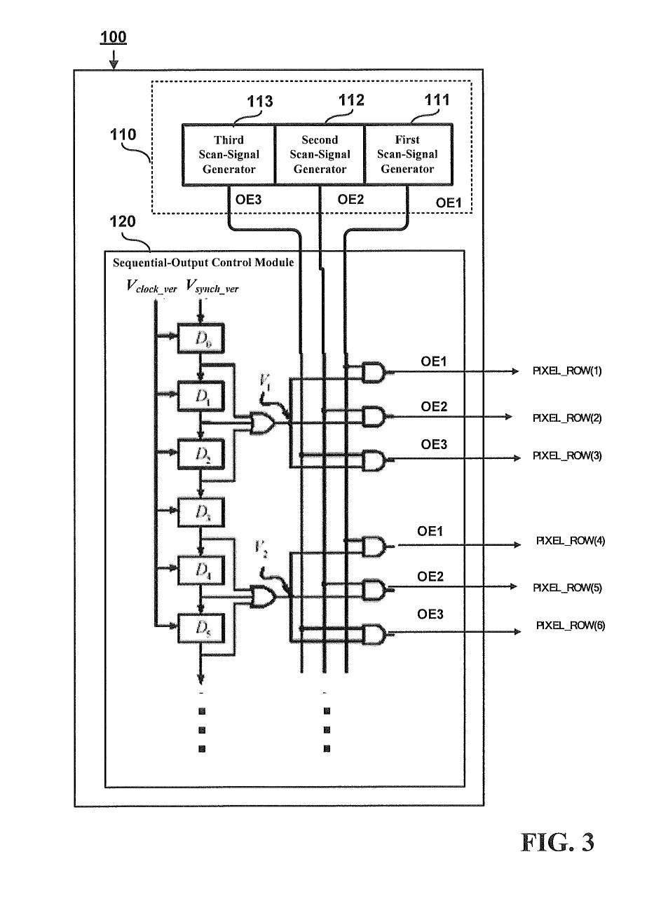

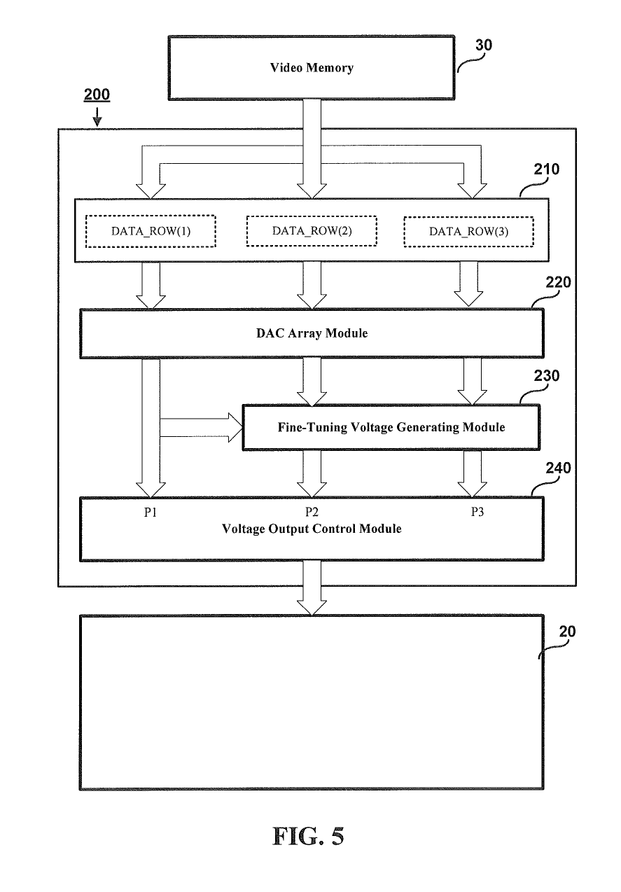

As shown in FIG. 1B, in architecture, the dot-matrix display charging control system of the invention 40 comprises two separate units: (A) a scan circuit 100; and (B) a data drive circuit 200; and as shown in FIG. 3, the scan circuit 100 includes: (A1) a scan-signal generating module 110; and (A2) a sequential-output control module 120; while as shown in FIG. 5, the data drive circuit 200 includes: (B1) a data-latching module 210; (B2) a digital-to-analog converter (DAC) array module 220; (B3) a fine-tuning voltage generating module 230; and (B4) a voltage output control module 240.

### Internal Architecture of Scan Circuit 100

Firstly, the respective attributes and functions of the constituent components 110, 120 of the scan circuit 100 are described in details in the following.

### Scan-Signal Generating Module 110

The scan-signal generating module 110 is designed to generate a combined set of L scan signals concurrently at the same time and repeatedly for a predefined scan period T_{scan}, where L is a predetermined number which can be either 2, 3, 4, or more. Preferably, L=3 is chosen for best mode embodiment. In the case of L=3, the scan-signal generating module 110 is composed of 3 scan-signal generators, including a first scan-signal generator 111, a second scan-signal generator 112, and a third scan-signal generator 113, which are used in combination for generating a combined set of 3 scan signals (OE1, OE2, OE3) concurrently at the same time and repeatedly for a predefined scan period T_{scan}. Further, one of the 3 scan signals (OE1, OE2, OE3) is configured as a master scan signal, and the others are configured as slave scan signals. In this embodiment, for example, the first scan signal OE1 is chosen as master scan signal, while OE2 and OE3 are chosen as slave scan signals.

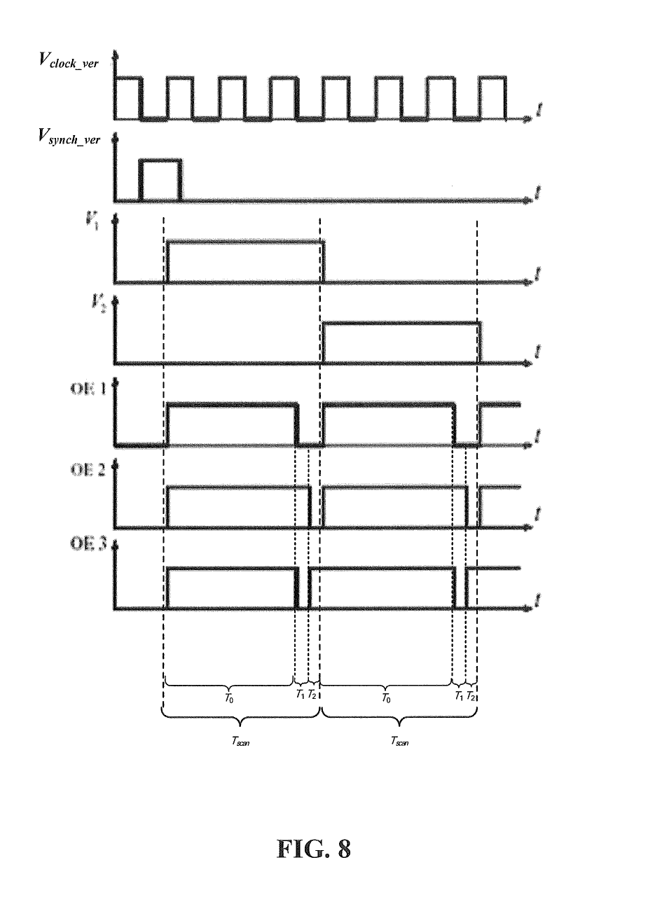

FIG. 8 shows the waveform and sequencing of the 3 scan signals (OE1, OE2, OE3). As shown, the time length of each scan period T_{scan} is divided into three stages: one master charging stage T₀ and two succeeding fine-tuning stages (T₁, T₂). During the master charging stage T₀, all of the scan signals (OE1, OE2, OE3) are set to logic-HIGH state; during the succeeding first fine-tuning stage T₁, the master scan signal OE1 and the second slave scan signal OE3 are switched to logic-LOW state, while only the first slave scan signal OE2 remains at logic-HIGH state; and subsequently during the second fine-tuning stage T₂, the master scan signal OE1 remains at logic-LOW state, the first slave scan signal OE2 is switched to logic-LOW state, and the second slave scan signal OE3 is switched to logic-HIGH state.

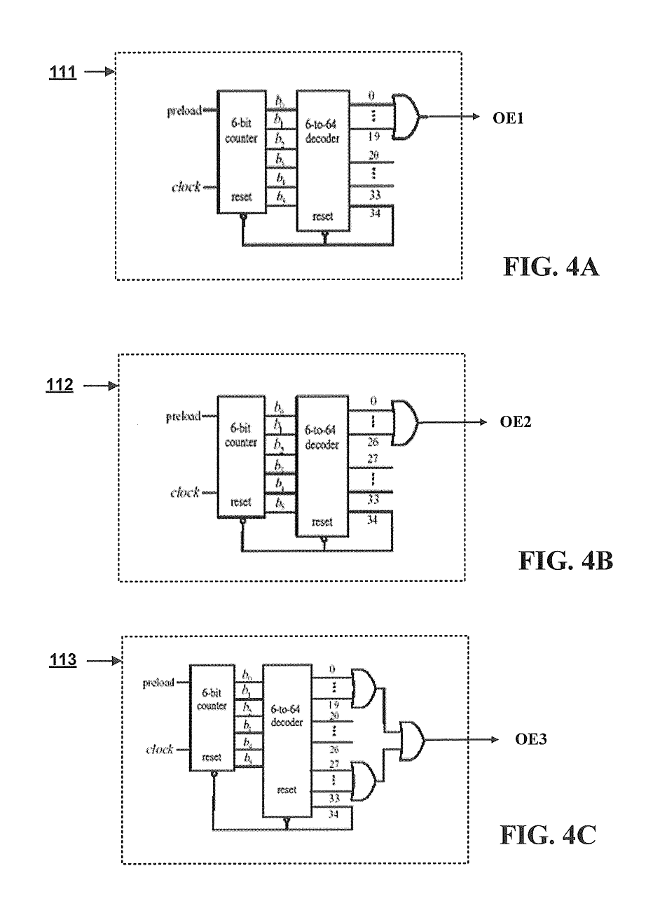

In practice, there are various different circuit architectures that can be used for implementation of the scan-signal generators 111, 112, 113 in the scan-signal generating module 110. FIGS. 4A-4C respectively show an example of the internal circuit architectures of the first scan-signal generator 111, the second scan-signal generator 112, and the third scan-signal generator 113. Beside this, various other circuit architectures are possible.

### Sequential-Output Control Module 120

The sequential-output control module 120 is designed to control the outputting of the above-mentioned 3 scan signals (OE1, OE2, OE3) in a sequential manner and concurrently to a group of 3 consecutive pixel rows in the dot-matrix panel 20. Specifically speaking, during the first scan period T_{scan}, the 3 scan signals (OE1, OE2, OE3) are outputted to the first three pixel rows [PIXEL_ROW(1), PIXEL_ROW(2), PIXEL_ROW(3)] in the dot-matrix panel 20; subsequently during the second scan period T_{scan}, the 3 scan signals (OE1, OE2, OE3) are outputted to the next three pixel rows [PIXEL_ROW(4), PIXEL_ROW(5), PIXEL_ROW(6)]; and subsequently during the third scan period T_{scan}, the 3 scan signals (OE1, OE2, OE3) are outputted to the next three pixel rows [PIXEL_ROW(7), PIXEL_ROW(8), PIXEL_ROW(9)]; and so forth.

When the 3 scan signals (OE1, OE2, OE3) are outputted to the dot-matrix panel 20, a logic-HIGH state will cause the corresponding pixel row to be set to ON state (i.e., charging-enabled state), while a logic-LOW state will cause the corresponding pixel row to be set to OFF state (i.e., charging-inhibited state).

In practice, there are various different circuit architectures that can be used for implementation of the sequential-output control module 120. FIG. 3 shows an example of a circuit architecture for realizing the sequential-output control module 120. As shown, in this circuit architecture, a shift register is used to convert a clock signal V_{clock}_{_{—}}ᵥₑᵣ and a synchronization signal V_{sync}_{_{—}}ᵥₑᵣ into [V₁, V₂, . . . , V_{N/3}] which are sequentially switched to logic-HIGH state during each scan period T_{scan}; and the signals [V₁, V₂, . . . , V_{N/3}] are used to control an array of logic-AND gates for sequentially outputting the 3 scan signals (OE1, OE2, OE3) concurrently to the dot-matrix panel 20. The waveform and sequencing of V_{clock}_{_{—}}ᵥₑᵣ, V_{sync}_{_{—}}ᵥₑᵣ, [V₁, V₂] as well as (OE1, OE2, OE3) are illustrated in FIG. 8. It is to be noted that the realization of the sequential-output control module 120 is not limited to the circuit architecture shown in FIG. 3.

Internal Architecture of Data drive Circuit 200

Next, the respective attributes and functions of the constituent components 210, 220, 230, and 240 of the data drive circuit 200 are described in details in the following.

### Data-Latching Module 210

The data-latching module 210 is capable of reading a number L of video frame data rows from the video memory 30 in a sequential manner and latching these data rows therein. In this embodiment, since L=3, the data-latching module 210 will read 3 data rows from the video memory 30 during each scan period T_{scan} of a data-refresh process; i.e., during the first scan period T_{scan}, the data-latching module 210 reads and latches the first 3 data rows [DATA_ROW(1), DATA_ROW(2), DATA_ROW(3)] from the video memory 30; during the second scan period T_{scan}, the next 3 data rows [DATA_ROW(4), DATA_ROW(5), DATA_ROW(6)] are read and latched; subsequently during the third scan period T_{scan}, the next 3 data rows [DATA_ROW(7), DATA_ROW(8), DATA_ROW(9)] are read and latched; and so forth. As shown in FIG. 5, the data-latching module 210 can 20 latch three data rows at the same time, wherein the data row latched to the leftmost position is used as a master data row, while the other two data rows are used as slave data rows.

### DAC Array Module 220

The DAC array module 220 is composed of an array of digital-to-analog converters (DAC) which are used respectively for converting the digitized data of each pixel in each of the 3 data rows latched in the data-latching module 210 into an analog data voltage. The output analog data voltages of the master data row are directly transferred to the voltage output control module 240, while the output analog data voltages of the slave data rows are first transferred to the fine-tuning voltage generating module 230.

### Fine-Tuning Voltage Generating Module 230

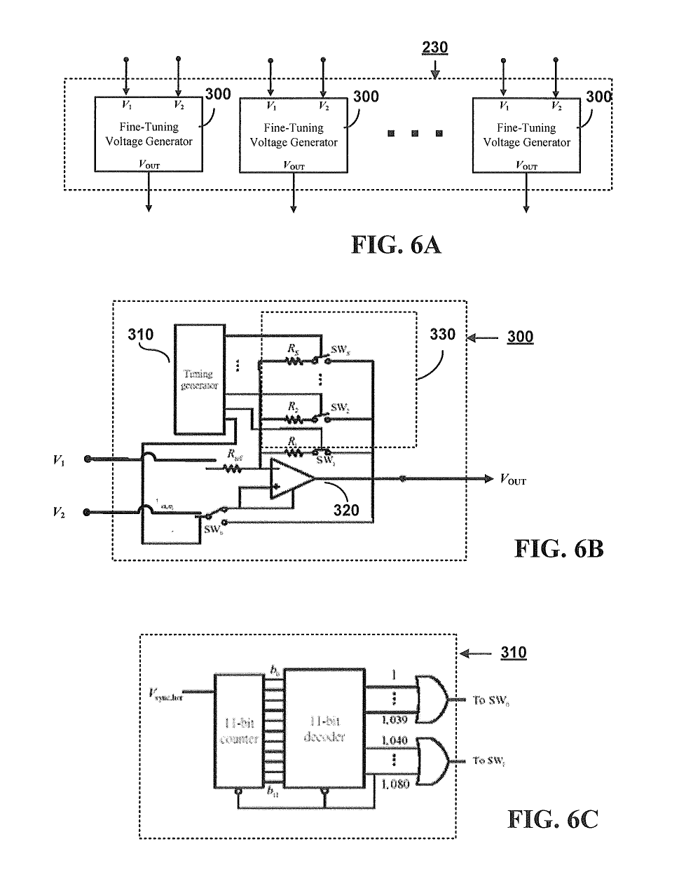

As shown in FIG. 6A, the fine-tuning voltage generating module 230 is composed of an array of fine-tuning voltage generators 300, each of which has two input ports (V₁, V₂) and an output port Vₒᵤₜ, and is used for generating a fine-tuning voltage by comparing the data voltage of each pixel in each slave data row against the data voltage of each corresponding pixel in the master data row, which are respectively received at the input ports (V₁, V₂). The resulted differential voltage is generated at the output port Vₒᵤₜ.

Taking the first 3 data rows [DATA_ROW(1), DATA_ROW(2), DATA_ROW(3)] as example, the first data row DATA_ROW(1) is latched as master data row while the other two data rows DATA_ROW(2) and DATA_ROW(3) are latched as slave data rows. In this case, during the first fine-tuning stage T₁ of the scan period T_{scan}, the fine-tuning voltage generating module 230 will generate a parallel set of M fine-tuning voltages by comparing the data voltage of each pixel in the first slave data row DATA_ROW(2) against the data voltage of each corresponding pixel in the master data row DATA_ROW(1), and use the differential voltages as fine-tuning voltages for PIXEL_ROW(2). Subsequently, during the second fine-tuning stage T₂ of the scan period T_{scan}, the fine-tuning voltage generating module 230 will generate a parallel set of M fine-tuning voltages by comparing the data voltage of each pixel in the second slave data row DATA_ROW(3) against the data voltage of each corresponding pixel in the master data row DATA_ROW(1), and use the differential voltages as fine-tuning voltages for PIXEL_ROW(3).

In practice, there are various different circuit architectures that can be used for implementation of the fine-tuning voltage generators 300. In ideal case, the fine-tuning voltage generators 300 can be each realized by using an analog voltage comparator. In practice, however, since the pixels in the dot-matrix panel 20 are located at different distances from the data drive circuit 200, a pixel located farther from the data drive circuit 200 should be connected to a lengthy bus line, which would undesirably cause the data transfer over this lengthy bus line to be subjected to a greater capacitive effect, thus resulting in a larger charging time constant that would cause a delay in the charging process. Therefore, for those pixels located farther from the data drive circuit 200, the fine-tuning voltages applied thereto should be correspondingly increased in magnitude. As a solution to this problem, the N pixel rows [PIXEL_ROW(1), PIXEL_ROW(2), . . . , PIXEL_ROW(N)] in the dot-matrix panel 20 are segmented into N/3 subgroups, each segmented subgroup containing a predetermined number of pixel rows, such as 3 rows; and the charging time constant associated with the middle pixel row in each subgroup is chosen as a common charging time constant for all of the pixel rows in the subgroup. In the case of 3-row subgroups, the total number of subgroups is N/3. The total number of subgroups can be further reduced by grouping those pixel rows whose charging time constants are approximately close, which can help reduced the complexity of circuit implementation. The common charging time constant is then taken into consideration in the design of the fine-tuning voltage generators 300 for adaptively adjusting the output fine-tuning voltages based on the segmented locations of the destination pixel rows. This type of fine-tuning voltage generator 300 is referred to as a row-segmentation adaptive fine-tuning voltage generator. One example of such a row-segmentation adaptive fine-tuning voltage generator 300 is shown in FIG. 6B, which includes a timing controller 310, an analog voltage comparator 320, and a resistor matrix 330. The internal circuit architecture of the timing controller 310 is shown in FIG. 6C. The operation of the row-segmentation adaptive fine-tuning voltage generator 300 of FIG. 6B is sequentially controlled by the timing controller 310 to provide an adaptively-adjusted voltage output through the resistor matrix 330. The principle and circuit architecture of the row-segmentation adaptive fine-tuning voltage generator is disclosed in the technical paper entitled “PRECISE CHARGING METHOD WITH MULTIPLE ROWS” and “ACTIVE AND ADAPTIVE CHARGING METHOD ON DATA LINES FOR DELAY COMPENSATION” by Chun-Hsi et al, so detailed description thereof will not be given in this specification.

It is to be noted that the realization of the row-segmentation adaptive type of fine-tuning voltage generator 300 is not limited to the circuit architecture shown in FIGS. 6B-6C, and various other circuit architectures are possible.

Moreover, in the case that the dot-matrix display device 10 is constructed on a new technology that allows all the pixels to be equally distanced from the data drive circuit 200 (i.e., all pixels are associated with the same charging time constant), then the use of the row-segmentation adaptive fine-tuning voltage generator will be unnecessary. In this case, the fine-tuning voltage generators 300 can be directly realized by using a conventional analog voltage comparator.

### Voltage Output Control Module 240

The voltage output control module 240 is capable of being controlled by the 3 scan signals (OE1, OE2, OE3) generated by the scan circuit 100 to control the outputting of charging voltages to the dot-matrix panel 20. The voltage output control module 240 has 3 input ports [P1, P2, P3] and operates in such a manner that, during the master charging stage T₀ of each scan period T_{scan}, the first port P1 is connected to the dot-matrix panel 20 to allow the DA-converted data voltages of the M pixels of the master data row latched in the scan-signal generating module 11 0 to be charged to all of the pixel rows in the dot-matrix panel 20 that are currently switched on by the scan signals (OE1, OE2, OE3); and subsequently during the first fine-tuning stage T₁ of the scan period T_{scan}, the second port P2 is connected to the dot-matrix panel 20 to allow the first set of M fine-tuning voltages generated by the M fine-tuning voltage generators 300 in the fine-tuning voltage generating module 230 to be applied to the pixel row in the dot-matrix panel 20 that is currently switched on by the first slave scan signal OE2; and finally during the second fine-tuning stage T₂ of the scan period T_{scan}, the third port P3 is connected to the dot-matrix panel 20 to allow the second set of M fine-tuning voltages generated by the M fine-tuning voltage generators 300 in the fine-tuning voltage generating module 230 to be applied to the pixel row in the dot-matrix panel 20 that is currently switched on by the second slave scan signal OE3.

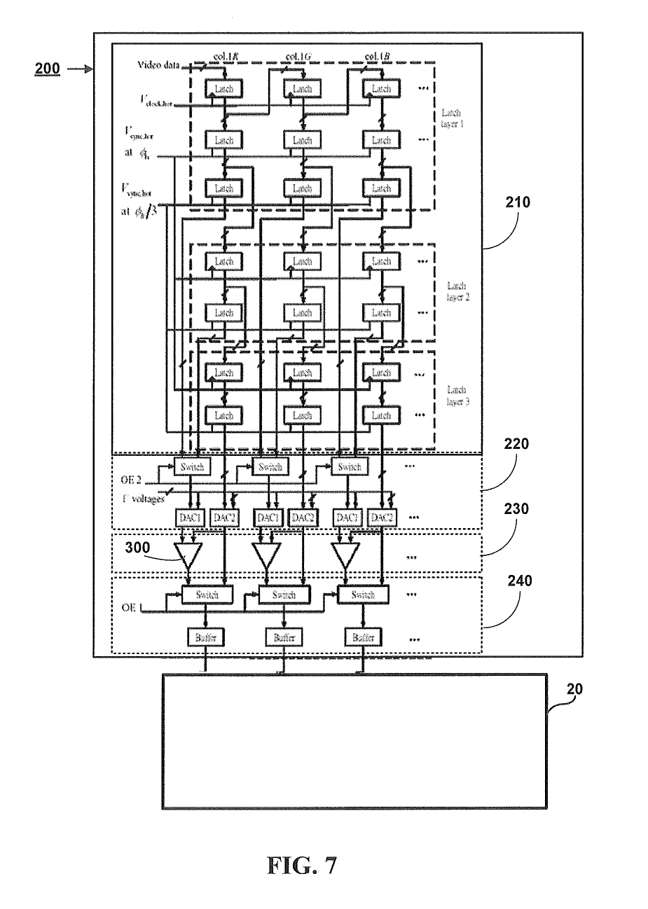

In practice, there are various different circuit architectures that can be used for implementation of the data drive circuit 200. FIG. 7 shows an example of a circuit architecture for realizing the data drive circuit 200. It is to be noted that various other circuit architectures are possible.

### Operation of the Invention

The following is a detailed description of the operation of the dot-matrix display charging control system of the invention 40. During operation, the dot-matrix display charging control system of the invention 40 is responsible for controlling a data-refresh process on the dot-matrix panel 20.

In the first step, the data-latching module 210 is activated during the first scan period T_{scan}, to read the first 3 data rows [DATA_ROW(1), DATA_ROW(2), DATA_ROW(3)] of the current video frame to be displayed on the dot-matrix panel 20 from the video memory 30 and then latch these 3 data rows therein. At the same time, the 3 scan signals (OE1, OE2, OE3) generated by the scan-signal generating module 110 are controlled by the sequential-output control module 120 for outputting to the first 3 pixel rows [PIXEL_ROW(1), PIXEL_ROW(2), PIXEL_ROW(3)] in the dot-matrix panel 20.

During the master charging stage To of the first scan period T_{scan}, all of the 3 scan signals (OE1, OE2, OE3) are at logic-HIGH state, thereby activating all of the 3 pixel rows [PIXEL_ROW(1), PIXEL_ROW(2), PIXEL_ROW(3)] to charging-enabled state. At the same time, the voltage output control module 240 is activated to connect the first port P1 to the dot-matrix panel 20, thus allowing the DA-converted data voltages of the M pixels of the master data row DATA_ROW(1) latched in the data-latching module 210 to be charged concurrently to all the corresponding M pixels in the 3 pixel rows [PIXEL_ROW(1), PIXEL_ROW(2), PIXEL_ROW(3)].

Subsequently during the first fine-tuning stage T₁ of the scan period T_{scan}, OE1 and OE3 are switched to logic-LOW state, while only OE2 remains at logic-HIGH state. This causes only PIXEL_ROW(2) to remain at charging-enabled state, while the other two pixel rows DATA_ROW(1) and DATA_ROW(3) are switched to charging-inhibited state. At the same time, the M pixels of the first slave data row DATA_ROW(2) latched in the data-latching module 210 are DA-converted by the DAC array module 220 into M analog data voltages, and then compared by the fine-tuning voltage generating module 230 against the M data voltages of the master data row DATA_ROW(1) in a column-wise manner, whereby a parallel set of M fine-tuning voltages are generated. If the color value of a certain pixel in the slave data row DATA_ROW(2) is greater than the color value of the corresponding pixel in the same column in the master data row DATA_ROW(1), then the resultant fine-tuning voltage is positive in magnitude; whereas if smaller, the resultant fine-tuning voltage is negative in magnitude; and if equal, the resultant differential voltage is zero magnitude. At the same time, the voltage output control module 240 is activated to connect the second port P2 to the dot-matrix panel 20 to allow these M fine-tuning voltages to be applied to the M pixels in the second pixel row PIXEL_ROW(2). For each pixel in PIXEL_ROW(2), if the applied fine-tuning voltage is positive, it will increase the current data voltage level on that pixel which was previously charged with the data voltage of the master data row, thereby adjusting the data voltage level on the pixel to its intended level. On the other hand, if the applied fine-tuning voltage is negative, it will decrease the current data voltage level on the pixel, thereby adjusting the data voltage to its intended level.

Subsequently during the second fine-tuning stage T₂ of the scan period T_{scan}, OE1 remains at logic-LOW state, OE2 is switched to logic-LOW state, and OE3 is switched to logic-HIGH state. This causes PIXEL_ROW(3) to be switched on to charging-enabled state, while the other two pixel rows DATA_ROW(1) and DATA_ROW(2) are set to charging-inhibited state. At this time, the M pixels of DATA_ROW(3) latched in the data-latching module 210 are DA-converted by the DAC array module 220 into analog data voltages, and then compared by the fine-tuning voltage generating module 230 against the M data voltages of the master data row DATA_ROW(1), whereby a parallel set of M fine-tuning voltages are generated. At the same time, the voltage output control module 240 is activated to connect the third port P3 to the dot-matrix panel 20 to allow these M output fine-tuning voltages to be applied to the M pixels in the third pixel row PIXEL_ROW(3), thereby adjusting the current data voltage on each pixel to the intended level. This completes the data-refresh process on the first 3 pixel rows [PIXEL_ROW(1), PIXEL_ROW(2), PIXEL_ROW(3)] in the dot-matrix panel 20.

After the data refresh on [PIXEL_ROW(1), PIXEL_ROW(2), PIXEL_ROW(3)] is completed, the data-latching module 210 is activated to read and latch the next 3 data rows [DATA_ROW(4), DATA_ROW(5), DATA_ROW(6)] from the video memory 30; and meanwhile, the 3 scan signals (OE1, OE2, OE3) are outputted to the next 3 pixel rows [PIXEL_ROW(4), PIXEL_ROW(5), PIXEL_ROW(6)]. The same data-refresh process is then repeated again for writing [DATA_ROW(4), DATA_ROW(5), DATA_ROW(6)] respectively to [PIXEL_ROW(4), PIXEL_ROW(5), PIXEL_ROW(6)].

After the data refresh on [PIXEL_ROW(4), PIXEL_ROW(5), PIXEL_ROW(6)] is completed, the data-latching module 210 is activated to read and latch the next 3 data rows [DATA_ROW(7), DATA_ROW(8), DATA_ROW(9)] from the video memory 30; and meanwhile, the 3 scan signals (OE1, OE2, OE3) are outputted to the next 3 pixel rows [PIXEL_ROW(7), PIXEL_ROW(8), PIXEL_ROW(9)]. The same data-refresh process is then repeated again for writing [DATA_ROW(7), DATA_ROW(8), DATA_ROW(9)] respectively to [PIXEL_ROW(7), PIXEL_ROW(8), PIXEL_ROW(9)].

The foregoing data-refresh process is repeated again and again until the last 3 pixel rows [PIXEL_ROW(N-2), PIXEL_ROW(N-1), PIXEL_ROW(N)] are refreshed. This completes the data refresh of a new video frame to the dot-matrix panel 20.

It is to be noted that the above-described embodiment of the invention is implemented with the first data row in each group of latched data rows as the master data row whose DC-converted data voltages are applied to all of the selected 3 pixel rows during the master charging stage. In other embodiments, either the second or the third data row can be chosen as the master data row. Moreover, the concurrent selection of pixel rows in the dot-matrix panel is not limited to 3 pixel rows, and can be 2, 4, 5, or more.

In conclusion, the invention provides a dot-matrix display charging control method and system, which is characterized by the capability of concurrently selecting a number of consecutive pixel rows in the dot-matrix panel for charging all of the pixel rows with the same set of data voltages from a master data row that is intended to be applied to one of the selected pixel rows, and then fine-tuning every other pixel row with a set of differential voltages based on the value differences between the master data row and a slave data row that is intended to be applied to the other pixel row. This feature allows the operation of a dot-matrix display device to use a long charging time for data refresh under a fast scan speed. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A dot-matrix display charging control method for use on a dot-matrix display device equipped with a dot-matrix panel and a video memory for controlling a data-refresh process on the dot-matrix display device;
the dot-matrix display charging control method comprising:
periodically generating a predetermined number of scan signals including a master scan signal and at least one slave scan signal during a predefined scan period; wherein each scan period is divided into a master charging stage and at least one succeeding fine-tuning stage;
during the master charging stage of each scan period, setting the scan signals to concurrently switch a corresponding number of pixel rows in the dot-matrix display device to charging-enabled state, and then charging a set of data voltages associated with the pixel row activated by the master scan signal to all the pixel rows selected by the scan signals; and
during each fine-tuning stage of the scan period, setting the master scan signal to switch the corresponding pixel row to charging-inhibited state and meanwhile setting each slave scan signal to sequentially activate the corresponding pixel row to charging-enabled state, and then charging a set of fine-tuning voltages which are based on the differences between a master data row and a slave data row that are to be refreshed to the pixel rows selected by the master scan signal and each slave scan signal.

2. The dot-matrix display charging control method of claim 1, wherein the dot-matrix display device is a TFT-LCD (Thin Film Transistor Liquid Crystal Display) device.

3. The dot-matrix display charging control method of claim 1, wherein the charging of the fine-tuning voltages is based on a row-segmentation adaptive fine-tuning scheme that is capable of adaptively adjusting the fine-tuning voltages based on different charging time constants associated with the pixel rows of the dot-matrix panel.

4. A dot-matrix display charging control system for integration to a dot-matrix display device equipped with a dot-matrix panel and a video memory for controlling a data-refresh process on the dot-matrix display device;
the dot-matrix display charging control system comprising: a scan circuit and a data drive circuit;
wherein
the scan circuit includes:
a scan-signal generating module, which is capable of periodically generating a predetermined number of scan signals including a master scan signal and at least one slave scan signal during a predefined scan period; wherein each scan period is divided into a master charging stage and at least one succeeding fine-tuning stage; and during the master charging stage, the scan signals are configured to switch a corresponding number of pixel rows in the dot-matrix display device to charging-enabled state; and during each fine-tuning stage, the master scan signal is configured to switch the corresponding pixel row to charging-inhibited state while each slave scan signal is sequentially configured to switch the corresponding pixel row to charging-enabled state;
a sequential-output control module, which is capable of sequentially controlling the outputting of the scan signals generated by the scan-signal generating module to the dot-matrix panel;
and wherein
the data drive circuit includes:
a data-latching module, which is capable of sequentially reading a predetermined number of data rows equal to the number of scan signals from the video memory and latching one of these data rows as a master data row and every other one as a slave data row;
a digital-to-analog converter array module, which is capable of converting each pixel in each of the data rows latched in the data-latching module into a corresponding analog data voltage;
a fine-tuning voltage generating module, which is capable of generating a set of fine-tuning voltages by comparing the analog data voltages of each slave data row against the analog data voltages of the master data row latched in the data-latching module; and
a voltage output control module, which is capable of selectively control the outputting of the analog data voltages of the master data row and the outputting of the fine-tuning voltages generated by the fine-tuning voltage generating module to the dot-matrix panel, in such a manner that during the master charging stage of each scan period, the analog data voltages of the master data row are outputted to the dot-matrix panel; and during each fine-tuning stage of the scan period, the fine-tuning voltages generated by the fine-tuning voltage generating module are outputted to the dot-matrix panel.

5. The dot-matrix display charging control system of claim 4, wherein the dot-matrix display device is a TFT-LCD (Thin Film Transistor Liquid Crystal Display) device.

6. The dot-matrix display charging control system of claim 4, wherein the fine-tuning voltage generating module includes an array of fine-tuning voltage generators, each of which is implemented with an analog voltage comparator.

7. The dot-matrix display charging control system of claim 4, wherein the fine-tuning voltage generating module includes an array of fine-tuning voltage generators, each of which is implemented with a row-segmentation adaptive fine-tuning voltage generator that is capable of adaptively adjusting the fine-tuning voltages based on different charging time constants associated with the pixel rows of the dot-matrix panel.
